(19) United States
(12) Patent Application Publication
(10) Pub. No.: US 2006/0226588 A1
(43) Pub. Date: Oct. 12, 2006

(54) Quick release bar clamp

(75) Inventors: Zareh Khachatoorian, Northridge, CA (US); Karen Gasparyan, Yerevan (AM); Patvakan Hakhinyan, Yerevan (AM); Thomas J. Wheeler, Pomona, CA (US)

Correspondence Address: MOSER, PATTERSON & SHERIDAN, SUITE 1500, 3040 POST OAK BOULEVARD, HOUSTON, TX, 77056, US

(73) Assignee: Industrial Technologies Company L.L.C.

(21) Appl. No.: 11/105,225

(22) Filed: Apr. 12, 2005

(51) Int. Cl. B25B 1/00

(52) U.S. Cl. 269/6

(57) ABSTRACT

A method and apparatus for clamping a work piece is disclosed. The apparatus generally includes a stationary jaw disposed on a bar and having a first clamping surface and a moveable jaw disposed on the bar and having a second clamping surface. The apparatus further comprises a drive handle which provides movement of the moveable jaw relative to the bar. The drive handle can be configured to move the second clamping surface at different rates and forces when operated.

### BACKGROUND OF THE INVENTION

1. Field of the Invention

Embodiments of the present invention generally relate to a hand tool and more particularly to a clamp. More particularly still, embodiments of the invention relate to a bar clamp with improved performance and utility.

2. Description of the Related Art

Clamps are used in order to temporarily hold one or more objects so that work can be performed on them. Historically, clamps required two hands in order to work the clamp making it difficult to hold the work piece while clamping. A vast improvement to clamps was made about 15 years ago with the advent of the QUICK-GRIP™ bar clamp, disclosed in U.S. Pat. No. 5,009,134, and QUICK-ACTION™ bar clamp, disclosed in U.S. Pat. No. 4,926,722 to Joseph A. Sorensen and Dwight L. Gatzemeyer. The QUICK-GRIP™ bar clamp provides a single hand clamping tool that allows one free hand to support the work piece or hold other tools and/or materials while clamping the work piece. This is a major improvement over the traditional screw activated “C” clamps or “over center” type lever actuated bar clamps.

However, several problems exist with the QUICK-GRIP™ bar clamp. The QUICK-GRIP™ clamp must balance between the amount of force required by the hand and the amount of movement of the clamp for each squeeze of the hand. The amount of force exerted on the work piece in relation to the force exerted by the hand is determined by the mechanical advantage ratio (MAR) of the mechanism. As the MAR is increased, the amount of force on the clamp is increased, and the amount of force required to squeeze the handle is decreased. However, in the current hand clamps, the distance the clamp travels with each squeeze (or bar index) decreases if the MAR is increased. Thus, the current clamps on the market compromise by providing a MAR of about 4.5:1 and an index distance of 0.2 inches/squeeze. As people get older, the amount of strength in the hand decreases drastically making it more difficult to operate the QUICK-GRIP™ bar clamp or similar products. As the population ages, it is necessary to provide for a clamp that can increase the MAR and the bar index while requiring minimal squeezing force by the operator.

Therefore, a need exists for improved apparatus and methods of hand clamping that increase the force on the workpiece for a primary squeezing force, increase the travel of the clamp per squeeze, and decrease the manufacturing cost.

### SUMMARY OF THE INVENTION

Embodiments of the invention generally relate to methods and apparatus for clamping a work piece. A clamping apparatus generally includes a stationary jaw disposed on a bar and having a first clamping surface and a moveable jaw disposed on the bar and having a second clamping surface. The apparatus further comprises a drive handle that provides movement of the moveable jaw relative to the bar when operated. The drive handle can be configured to move the clamping surfaces at different rates and forces. For some embodiments, first and second portions of the drive handle pivot about first and second pivot diameters, respectively, such that the moveable jaw moves with different forces. The drive handle can include a drive pin in contact with drive links disposed around the bar to forceably grip and move the bar as the drive pin moves due to operation of the drive handle. In some embodiments, the drive links include a bend in a middle portion thereof so that a first portion above the bar is offset from a second portion below the bar when the drive link is in a non-rotated position with respect to the bar. For some embodiments, a rear handle opposes a force applied to the drive handle and selectively disengages the moveable jaw from the bar upon movement thereof. Further, a release lever can connect a housing of the stationary jaw to the first clamping surface to enable selective disengagement of the stationary jaw from the bar. A method of clamping the work piece comprises moving the drive handle through a first range of motion to move the movable jaw with a first force and moving the drive handle through a second range of motion to move the moveable jaw with a second force smaller than the first force.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front view of the bar clamp in accordance with embodiments of the invention.

FIG. 2 is a cross sectional view of the clamp.

FIG. 3 is a front view of the clamp showing a final position of a drive handle.

FIG. 4 is an isometric view of the clamp.

FIG. 5 is a cross sectional view of a moveable jaw further detailing an operation of a drive link(s).

FIG. 6 is an isometric view of an offset drive link.

### DETAILED DESCRIPTION

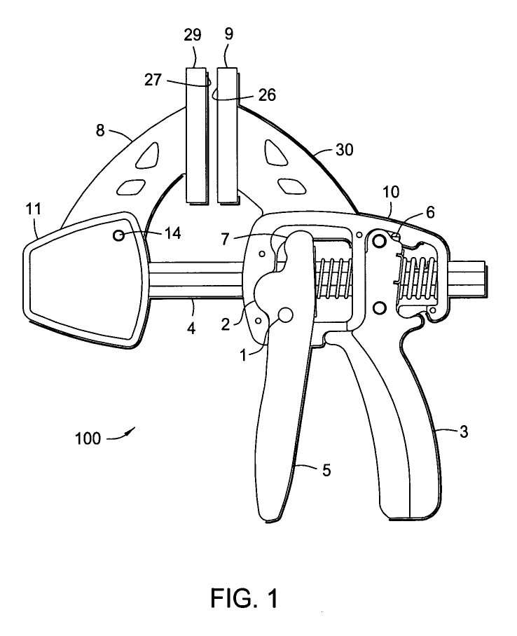

FIG. 1 illustrates a schematic front view of a hand clamp 100 having moveable and stationary jaw assemblies configured to incorporate embodiments of the invention. The hand clamp 100 includes a moveable jaw housing 10 having mating surfaces for a high reduction pivot diameter 2 and a low reduction pivot diameter 7 formed along one side of a drive handle 5. A drive pin 1 disposed through an aperture of the drive handle 5 substantially on one side of the high and low reduction pivot diameters 2, 7 enables pivotal movement of the drive handle 5 with respect to the moveable jaw housing 10. In addition, a rear handle/lock release 3 couples to the moveable jaw housing 10 for operating a locking link 6.

The hand clamp 100 further includes first and second clamp heads 9, 29 for gripping a work piece (not shown). Each clamp head 9, 29 includes first and second clamping surfaces 26, 27, respectively. The first clamp head 9 couples to the moveable jaw housing 10 via an arm 30. The second clamp head 29 couples to a stationary jaw housing 11 via a release lever 8. A bar 4 that the jaw housings 10 and 11 are disposed on connects the stationary jaw housing 11 to the moveable jaw housing 10.

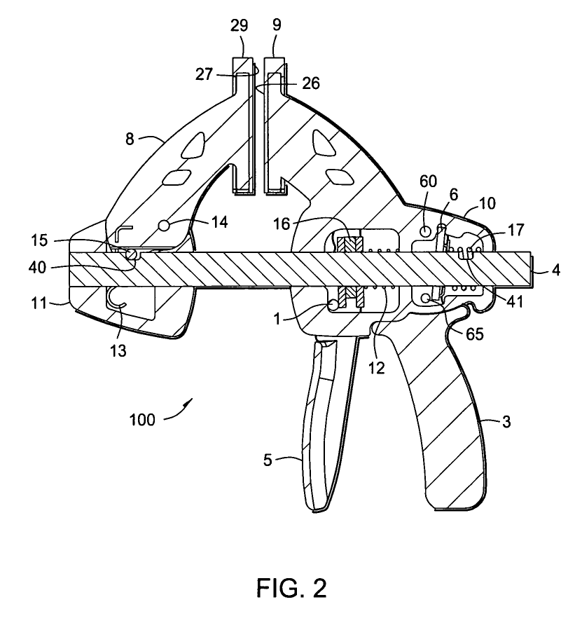

FIG. 2 shows a schematic cross sectional view of the hand clamp 100 with the stationary jaw pivot 14 that couples the stationary jaw housing 11 to the release lever 8. A stationary jaw locking dog 15 pivots with the release lever 8 about the stationary jaw pivot 14 to selectively lock the release lever 8 and hence the stationary jaw housing 11 to the bar 4. A biasing member or leaf spring 13 coupled to the release lever 8 contacts a portion of the stationary jaw housing 11 to urge the release lever 8 to rotate about the stationary jaw pivot 14 in a counter-clockwise direction. The rotation engages the locking dog 15 with a first notch 40 on the bar 4 to prevent the stationary jaw housing 11 from disengaging the bar 4. With the stationary jaw housing prevented from movement along the length of the bar 4, the position of the second head 29 is locked.

The bar 4 includes the first notch 40 and a corresponding second notch 41 on an opposite end thereof for convenience in assembly and manufacturing. The first notch 40 on the bar 4 locks the release lever 8 and attached stationary jaw housing 11 to the bar 4 with the locking dog 15. While the notch 41 is not needed for operation of the bar 4 with respect to the moveable jaw assembly, the notches 40, 41 are symmetrical to enable attachment of the stationary jaw housing 11 to either end of the bar 4 during assembly. This reduces manufacturing and assembly costs.

In operation, a drive link spring 12 disposed within the moveable jaw housing 10 biases the drive handle 5 to remain in an open position with the high reduction pivot diameter 2 engaged with the moveable jaw housing 10 when no outside force is exerted on the drive handle 5. A surface of the movable jaw housing 10 provides a backstop for the drive link spring 12 that acts on the drive handle 5 via drive links 16, shown here as three links, although it should be appreciated there can be any number of links. The drive links 16 have an aperture 50 (visible in FIG. 6) through which the bar 4 fits. The drive link spring 12 biases the drive links 16 substantially perpendicular to the bar 4 to enable the bar 4 to pass through the aperture 50 without gripping contact of the drive links 16 until force is exerted on the drive handle 5. With force exerted on the drive handle 5 to rotate the drive handle along the pivot diameters 2, 7, movement of the drive pin 1 pushes the lower end on the drive links 16 causing the drive links 16 to rotate counter-clockwise until respective bottom and top edges of the drive links 16 at the aperture 50 engage the bar 4. Accordingly, the number of edges available to grip the bar 4 increases with an increase in the number of the drive links 16 utilized. Continued movement of the drive handle 5 moves the drive links 16 with the bar 4 causing the stationary jaw housing 11 and the moveable jaw housing 10 to approach one another.

A locking link spring 17 disposed within the moveable jaw housing 10 such that the moveable jaw housing 10 provides a backstop for the locking link spring 17 exerts force on a center portion of the locking link 6. The locking link spring 17 acts to rotate the locking link 6 in a clockwise direction due to a top edge of the locking link 6 being trapped by a cavity formed in the moveable jaw housing 10. The rotation of the locking link 6 causes inside edges of the locking link 6 to normally engage the bar 4 and lock it into place to prevent relative movement between the bar 4 and the moveable jaw housing 10 that is coupled to the locking link 6. Upon squeezing the drive handle 5, the force exerted to move the bar 4 relative to the moveable jaw housing 10 by operation of the drive links 16 is enough to overcome the locking link spring 17 and enable the locking link 6 to release the bar 4. Release of the locking link 6 occurs due to the locking link 6 rotating to a substantially perpendicular position with respect to the bar 4 since movement of the bar 4 with respect to the movable jaw housing 10 having the trapped top edge of the locking link 6 causes counter-clockwise rotation of the locking link 6 against the bias of the locking link spring 17. When the drive handle 5 is released or force is otherwise no longer exerted by operation of the drive handle 5, the locking link spring 17 causes locking link 6 to reengage the bar 4.

When force is first applied to the drive handle 5, the high reduction pivot diameter 2 of the drive handle 5 engages with the moveable jaw housing 10. The MAR is determined approximately by the distance from where the load is applied on the drive handle 5 to the pivot diameter divided by the vertical component of the distance from the drive pin 1 to the pivot diameter. The MAR when the high reduction pivot diameter 2 is engaged is high, for example, about 8:1. It should be appreciated that the arrangement of the drive handle 5, the high reduction pivot diameter 2, and the drive pin 1 can be modified in order to raise or lower the MAR to suit the consumer. The high reduction pivot diameter 2 engages with the drive handle 5 for about half of the full stroke of the drive handle 5. The stroke length required to disengage the high reduction pivot diameter 2 can be modified for a given product. An average human hand produces the maximum squeezing force at the point where the stroke is one half complete. Thus, this embodiment gives the user the maximum clamping force by using a high MAR coupled with the maximum human squeezing force.

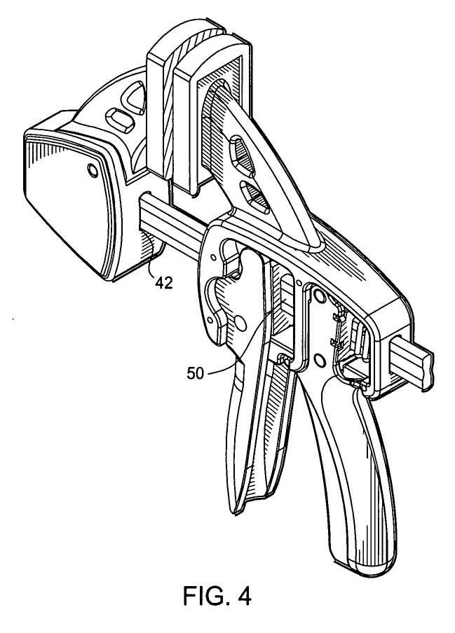

In summary, the squeezing force from the user's hand is transmitted to the drive handle 5 to rotate the drive handle 5 about the pivot diameters 2, 7, thereby moving the drive pin 1 which transfers force to the drive links 16 engaging the bar 4 to move the first clamp head 9 toward the second clamp head 29. The drive links 16 have the aperture 50 just slightly larger than the height of the bar 4 to enable the bar 4 to pass through the drive links, as shown in FIG. 4. When the drive links 16 rotate counter clockwise due to loading from the drive pin 1, the drive links 16 bind onto the bar 4 creating enough normal force at the binding points to transmit the squeezing force to the bar through friction.

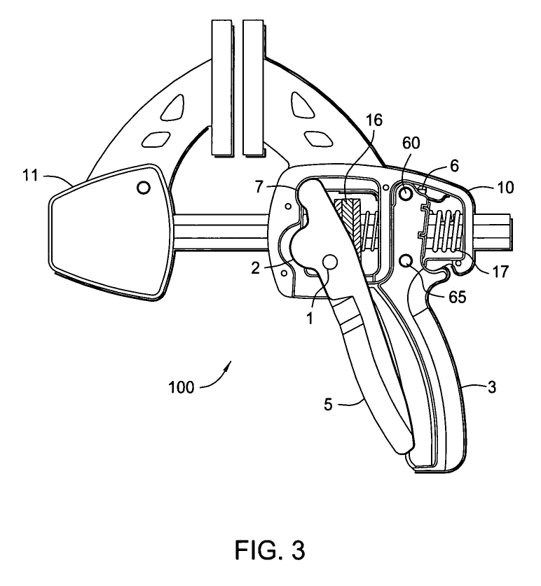

When the stroke of the drive handle 5 reaches about the half way point, the low reduction pivot diameter 7 of the drive handle 5 engages the moveable jaw housing 10. The high reduction pivot diameter 2 then disengages, as shown in FIG. 3. With low reduction pivot diameter 7 engaged, the MAR decreases because the distance from the drive pin 1 to the low reduction pivot diameter 7 increases. As shown, the MAR is low, for example, approximately 3.75:1, although it should be appreciated that adjustment in location of components can increase or decrease the MAR as desired. With the low reduction pivot diameter 7 engaged, a relatively small angular rotation of the drive handle 5 translates into a large axial travel of the bar 4 relative to the moveable jaw housing 10. This minimizes the number of squeezes required to engage the work piece.

Once the hand clamp 100 engages the work piece, the locking link 6 holds substantial force in order to prevent the bar 4 from slipping and allowing the movable jaw housing 10 and the clamp head 9 to move away from the stationary jaw housing 11 and clamp head 29. A release mechanism for the locking link 6 is incorporated into the rear handle/lock release 3, as shown in FIG. 3. The rear handle/lock release 3 attaches to the moveable jaw housing 10 at a pivot pin 60 and includes a release pin 65. The entire rear handle/lock release 3 pivots backwards about pivot pin 60 to move the release pin 65 in contact with a bottom portion of the locking link 6 in order to rotate the locking link 6 counter-clockwise and release the clamping pressure. This release mechanism provides a release with a long lever arm and an ergonomic handle shape, which helps the user operate the hand clamp 100 more efficiently. Thus, this release mechanism represents a substantial improvement over the prior art clamps which included releases made of flat sheet metal.

To release the stationary jaw housing 11 from the bar 4, the user grabs and rotates the release lever 8 clockwise against the bias of the leaf spring 13 to raise the locking dog 15 from the first notch 40. Then, the stationary jaw housing 11 slides freely on the bar 4 to enable removal of the entire stationary jaw assembly. The stationary jaw housing 11 reattaches to the bar 4 by inserting the bar into an opening 42 in the stationary jaw housing 11, as shown in FIG. 4, and sliding the stationary jaw housing 11 along the bar 4. The leaf spring 13 causes the locking dog 15 to find the first notch 40 in the bar 4 and snap into place.

For some embodiments, the hand clamp 100 can be used as a spreader with the clamping surfaces 26, 27 disposed within the work piece as is known in the art. Unlike the embodiments shown with the clamping surfaces 26, 27 facing one another, the clamping surfaces can accordingly be arranged to oppose one another to facilitate this spreader use of the clamp.

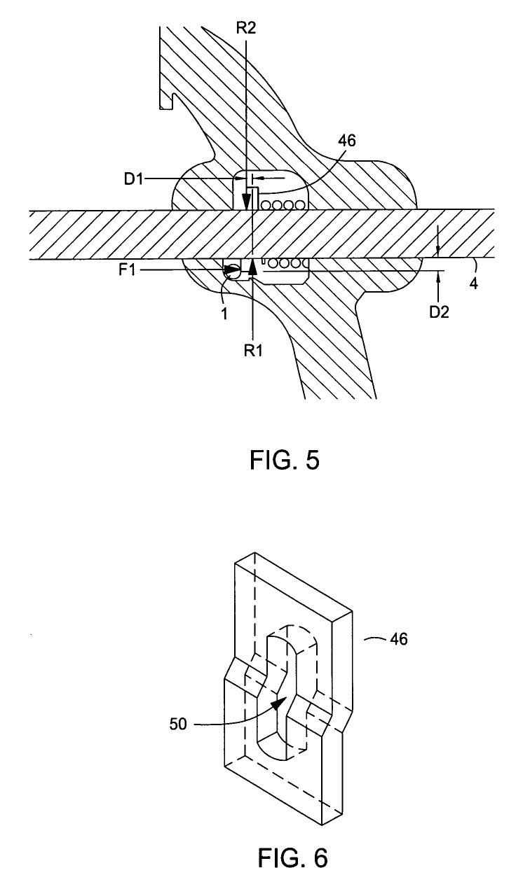

In another embodiment, the drive links 16 can be modified in order to more effectively increase the MAR. In order to increase the MAR, it is necessary for the drive pin 1 to be relatively close to the high reduction pivot diameter 2. This configuration requires the drive pin 1 to push on the drive links 16 at a relatively small distance from the edge of the bar 4. At some minimum distance, the drive links 16 no longer have enough frictional force with the bar 4 to drive the bar. Therefore, drive link(s) 46 provide an improved design that includes offset edges, as shown in FIGS. 5 and 6. A first distance D1, defined as the distance along the length of the bar 4 between the top front edge and the back bottom edge of the drive link 46 where the bar 4 is engaged, is reduced by having the offset. This reduction increases the magnitude of forces R1 and R2 engaging these edges of the drive link 46 with the bar 4. The forces R1 and R2 result from countering the moment created by driving force F1 from the pin 1 in contact with the drive link 46 and a second distance D2 defined as the distance from the bottom of the bar 4 to the location where the pin 1 contacts the drive link 46 to apply the driving force F1. This increase in the forces R1 and R2 permits the second distance D2 to be shorter and enables a higher MAR.

While the foregoing is directed to embodiments of the present invention, other and further embodiments of the invention may be devised without departing from the basic scope thereof, and the scope thereof is determined by the claims that follow.

1. A clamping apparatus, comprising:
a stationary jaw having a first clamping surface, the stationary jaw disposed on a bar; and
a moveable jaw assembly disposed on the bar and having a second clamping surface, comprising:
a housing;
a rear handle; and
a drive handle for providing movement of the moveable jaw assembly relative to the bar, wherein a first portion of the drive handle is configured to pivot about a first pivot diameter of the housing and a second portion of the drive handle is configured to pivot about a second pivot diameter of the housing such that the moveable jaw assembly is moveable with different forces.

2. The clamping apparatus of claim 1, further comprising a drive pin coupled to the drive handle.

3. The clamping apparatus of claim 2, wherein the drive pin abuts one or more drive links.

4. The clamping apparatus of claim 3, wherein the one or more drive links are rotatable to selectively engage the bar.

5. The clamping apparatus of claim 4, wherein the bar is removeably connected to the stationary jaw and moveable jaw.

6. The clamping apparatus of claim 5, wherein the bar is notched at the same location on both ends thereof.

7. The clamping apparatus of claim 1, wherein a first mechanical advantage ratio of greater than 4.5 to 1 is achieved when the drive handle is engaged with the first pivot diameter.

8. The clamping apparatus of claim 7, wherein a second mechanical advantage ratio less than 4.5 to 1 is achieved when the drive handle is engaged with the second pivot diameter.

9. A clamping apparatus, comprising:
a stationary jaw disposed on a bar and having a first clamping surface; and
a moveable jaw assembly disposed on the bar and having a second clamping surface, comprising:
a drive handle operable to move the second clamping surface relative to the first clamping surface; and
a rear handle disposed to oppose a force applied to the drive handle, wherein the rear handle is moveable to selectively disengage the moveable jaw assembly from the bar.

10. The clamping apparatus of claim 9, wherein the drive handle includes first and second pivot diameters for mating with surfaces on a housing of the moveable jaw assembly.

11. The clamping apparatus of claim 9, wherein the rear handle couples to a housing of the moveable jaw assembly at a pivot and a portion of the rear handle spaced from the pivot is disposed adjacent a locking link to act thereon, the locking link disposed on the bar and coupled to the moveable jaw assembly.

12. The clamping apparatus of claim 9, wherein the moveable jaw assembly further comprises:
a locking link for selectively coupling the moveable jaw assembly to the bar; and
a biasing member to urge the locking link in a first direction to engage the bar, wherein a release pin of the rear handle is disposed adjacent the locking link and is moveable with the rear handle in a second direction opposite the first direction in order to move the locking link in the second direction.

13. A clamping apparatus, comprising:
a stationary jaw assembly, comprising:
a housing disposed on a bar;
a release lever connecting the housing to a first clamping surface of the stationary jaw assembly, wherein the release lever is operable to selectively disengage the housing from the bar to enable sliding movement of the stationary jaw assembly with respect to the bar; and
a moveable jaw assembly disposed on the bar and having a second clamping surface, wherein the moveable jaw assembly includes a drive handle operable to move the moveable jaw assembly along the bar.

14. The clamping apparatus of claim 13, wherein the stationary jaw assembly includes a locking dog biased into engagement with a profile in the bar to engage the housing with the bar.

15. The clamping apparatus of claim 13, wherein the release lever pivotally couples to the housing, the release lever having a biasing member coupled thereto for engagement with a portion of the housing to bias the release lever such that a locking dog of the release lever engages a profile in the bar.

16. A clamping apparatus, comprising:
a stationary jaw disposed on a bar and having a first clamping surface; and
a moveable jaw assembly having a second clamping surface, comprising:
a drive link disposed around the bar, the drive link having a bend in a middle portion thereof so that a first portion above the bar is offset from a second portion below the bar when the drive link is in a non-rotated position with respect to the bar; and
a drive handle operable to move the second clamping surface relative to the first clamping surface, wherein a drive pin of the drive handle is disposed adjacent the drive link for engagement with the drive link to forceably move and grip the bar.

17. The clamping apparatus of claim 16, wherein the drive link is substantially rectangular and includes an aperture through which the bar fits.

18. A method of clamping a work piece, comprising:
providing a clamp having movable and stationary jaw assemblies disposed on a rod;
moving a gripping end of a drive handle of the movable jaw assembly with a primary force through a first range of motion to move the movable jaw assembly along the rod with a first force; and
moving the gripping end of the drive handle with the primary force through a second range of motion to move the movable jaw assembly along the rod with a second force smaller than the first force.

19. The method of claim 18, wherein moving the drive handle through the first and second ranges includes pivoting the drive handle about first and second diameters, respectively, defined by surfaces of a housing of the movable jaw assembly.

20. The method of claim 18, further comprising releasing the work piece by pivoting a release handle with respect to a housing of the movable jaw assembly to overcome a bias applied to a locking link of the movable jaw assembly, the release handle providing a counter force during the moving of the drive handle.
